(19) United States
(12) Patent Application Publication
(10) Pub. No.: US 2010/0185884 A1
(43) Pub. Date: Jul. 22, 2010

(54) STANDBY POWER SAVING SYSTEM AND COMPUTER POWER-ON AND POWER-OFF METHOD THEREOF

(76) Inventors: Chieh-Cheng Chen, Taoyuan Hsien (TW); Chih-Yuan Chang, Taoyuan Hsien (TW); Ching-Liang Chiu, Taoyuan Hsien (TW)

Correspondence Address: Muncy, Geissler, Olds & Lowe, PLLC, 4000 Legato Road, Suite 310, FAIRFAX, VA, 22033, US

(21) Appl. No.: 12/424,371

(22) Filed: Apr. 15, 2009

(30) Foreign Application Priority Data
Jan. 19, 2009 (TW) 098101853

(51) Int. Cl. G06F 1/32

(52) U.S. Cl. 713/321

(57) ABSTRACT

A standby power saving system includes a standby power control module connected to or disposed on a motherboard of a computer for bidirectional signal transmission and transmitting a control signal; and at least one receiving module disposed on at least one AC power line of the computer and/or at least one peripheral apparatus, and connected to the standby power control module for receiving the control signal to switch on or off AC powers of the computer and/or the peripheral apparatus.

### CROSS REFERENCE TO RELATED APPLICATIONS

This Non-provisional application claims priority under 35 U.S.C. §119(a) on Patent Application No(s). 098101853 filed in Taiwan, Republic of China on Jan. 19, 2009, the entire contents of which are hereby incorporated by reference.

### BACKGROUND OF THE INVENTION

1. Field of Invention

The present invention relates to a standby power saving system for monitoring the conditions of the computer, the monitor and the at least one peripheral apparatus, wherein the AC powers of the computer, the monitor and the peripheral apparatus are turned off according to the monitoring result or a command of a user, thereby reducing the consumed standby power.

2. Related Art

Depending on the power management function in the operating system, current desktop computers save the power by entering sleep mode or standby mode, etc, when the user doesn't operate the computer. However, when the computer shuts down and the AC power lines of the computer and its related peripheral apparatuses are still not removed from the sockets, there is still power consumed. The consumed power is standby power. Therefore, when the computer is in a power-on state, the power management function in the operating system only can save partial power. It cannot save the consumed standby power when the computer is in a power-off state.

When the computer is in a power-off state, the power-saving socket will monitor the consumed power of the computer, and the AC powers of the computer and the peripheral apparatus are cut off by switching off the connection between the power line of the computer and the socket. However, it only eliminates the standby power of the peripheral apparatuses because the power of the computer must be detected. Therefore, the standby power of the computer cannot be saved. Furthermore, when the AC powers of those peripheral apparatuses are cut off, all of the AC powers of those peripheral apparatuses will be cut off at the same time. It is not favorable for the user. Moreover, when the computer and the peripheral apparatuses are in a power-on state, the power-saving socket cannot save the standby powers of those peripheral apparatuses.

### SUMMARY OF THE INVENTION

It is an object of the present invention to provide a standby power saving system for monitoring the conditions of the computer, the monitor and the at least one peripheral apparatus, wherein the AC powers of the computer, the monitor and the peripheral apparatus is cut off according to the monitoring result or a command of a user, thereby reducing the consumed standby power.

It is another object of the present invention to provide a computer power-off method of a standby power saving system, wherein when the computer is in a power-off state, and only standby power remains, the AC powers of the computer, the monitor and the at least one peripheral apparatus is turned off by the standby power saving system.

It is further another object of the present invention to provide a computer power-on method of a standby power saving system. When the AC powers of the computer, the monitor and the at least one peripheral apparatus are turned off, and after the power ON/OFF button of the computer is pressed, the standby power saving system switches on the AC power of the computer. After the power of the computer is completely turned on, the AC powers of the monitor and the at least one peripheral apparatus are turned on.

To achieve the above, the present invention provides a standby power saving system including a standby power control module connected to or disposed on a motherboard of a computer for bidirectional signal transmission and transmitting a control signal; and at least one receiving module disposed on at least one AC power line of the computer and/or at least one peripheral apparatus, and connected to the standby power control module for receiving the control signal to switch on or off AC powers of the computer and/or the peripheral apparatus.

To achieve the above, the present invention also provides a computer power-off method of a standby power saving system. The standby power-off method includes steps of: providing a standby power control module connected to or disposed on a motherboard of a computer; enabling the computer to enter into a power-off mode; detecting that the computer is in a power-off state by the standby power control module; and transmitting a control signal to at least one receiving module corresponding to the computer and at least one peripheral apparatus to switch off AC powers of the computer and the peripheral apparatus by the standby power control module.

To achieve the above, the present invention also provides a computer power-on method of a standby power saving system. When the AC powers of a computer and at least one peripheral apparatus are turned off, the computer power-on method includes steps of: providing a standby power control module connected to or disposed on a motherboard of a computer; detecting that a power ON/OFF button of the computer is pressed by the standby power control module; transmitting a control signal to a receiving module disposed on an AC power line of the computer to switch on an AC power of the computer by the standby power control module; and transmitting a power-on signal to the motherboard by the standby power control module, and then enabling the computer to enter into a power-on mode. After the computer is in a power-on state, the AC powers of the monitor and the peripheral apparatus are turned on. When the AC power of the computer is turned on, the standby power of the computer is supplied by the power supply.

To sum up, by monitoring the conditions of the computer and the peripheral apparatus connected to the computer, when the computer and the peripheral apparatus are in a standby state for a predetermined period of time, the AC powers of the computer and the peripheral apparatus are turned off, thereby reducing the consumed standby-power of the computer and the peripheral apparatus.

When the computer enters into the power-off mode, and then the standby power control module detects that the computer is in a power-off state, the standby power control module transmits a control signal to a plurality of receiving modules corresponding to the computer and the peripheral apparatus to switch off the AC powers of the computer and the peripheral apparatus.

When the AC powers of the computer and the at least one peripheral apparatus are turned off, and the standby power control module detects that the power ON/OFF button of the computer is pressed, the AC power of the computer is recovered, and then enabling the computer to enter into a power-on mode. Then, after the computer is in a power-on state, the AC power of the peripheral apparatus is recovered.

### BRIEF DESCRIPTION OF THE DRAWINGS

The present invention will become more fully understood from the subsequent detailed description and accompanying drawings, which are given by way of illustration only, and thus are not limitative of the present invention, and wherein:

FIG. 1 is a block diagram illustrating a standby power saving system of the present invention;

FIG. 2 is a flow chart illustrating a computer power-off method of a standby power saving system of the present invention; and

FIG. 3 is a flow chart illustrating a computer power-on method of a standby power saving system of the present invention.

### DETAILED DESCRIPTION OF THE INVENTION

The present invention will be apparent from the following detailed description, which proceeds with reference to the accompanying drawing.

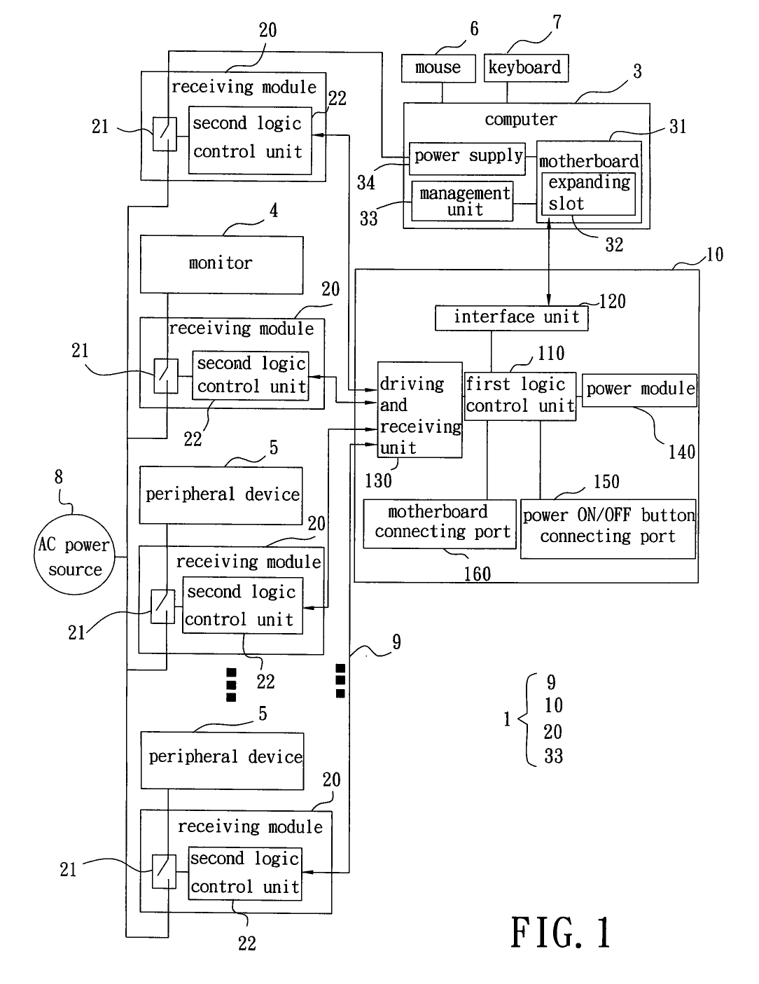

FIG. 1 is a block diagram illustrating a standby power saving system of the present invention. The standby power saving system 1 for cutting off or recovering the AC power of a computer 3, a monitor 4 and/or at least one peripheral apparatus 5 includes a standby power control module 10 and at least one receiving module 20.

The standby power control module 10 is connected to or disposed on a motherboard 31 of a computer 3 for bidirectional signal transmission and transmitting a control signal. The standby power control module 10 can be built on board and integrated onto the motherboard 31. Alternatively, the standby power control module 10 can be an interface card and inserted in an expanding slot 32 of the motherboard 31 for bidirectional signal transmission with the motherboard 31. The plurality of receiving module 20 are respectively disposed on the AC power lines of the computer 3, the monitor 4 and/or at least one peripheral apparatus 5, and respectively connected to the standby power control module 10 for receiving the control signal to switch on or off AC powers of the computer 3, the monitor 4 and/or the peripheral apparatus 5.

The standby power control module 10 includes a power module 140 and a first logic control unit 110. The power module 140 provides a power to the standby power control module 10 when the AC power of the computer 3 is switch off. When the computer 3 is in a power-on state, the power module 140 is charged via the motherboard 31 or an expanding slot 32 of the motherboard 31. The first logic control unit 110 receives the control signal from the computer 3 to switch on or off the AC powers of the computer 3, the monitor 4 and/or the at least one peripheral apparatus 5. As shown in FIG. 1, when the standby power control module 10 is an interface card, the standby power control module 10 further includes an interface unit 120 connected to the motherboard 31 for allowing the control signal transmitted from the computer 3 to the standby power control module 10.

In the embodiment of the present invention, the standby power control module 10 further includes a driving and receiving unit 130 for receiving and amplwhetherying the control signal transmitted from the first logic control unit 110, and transmitting the control signal to the corresponding receiving module 20. Alternatively, the driving and receiving unit 130 can also be disposed on the receiving module 20 (not shown).

The standby power control module 10 further includes a power ON/OFF button connecting port 150 and a motherboard connecting port 160. The power ON/OFF button connecting port 150 has one terminal connected to a power ON/OFF button of the computer 3, and the other terminal connected to the first logic control unit 110 for monitoring whether the power ON/OFF button is pressed or not. The motherboard connecting port 160 has one terminal connected to the motherboard 31, and the other terminal connected to the first logic control unit 110. When the receiving module 20 recovers the AC power of the computer 3, the standby power control module 10 transmits a power-on signal to the motherboard 31, and then the computer 3 enters into a power-on mode. This paragraph describes the operation mode in which the AC powers of the computer 3, the monitor 4 and at least one peripheral apparatus 5 are switched on at the same time. It will be described in detail later.

The receiving module 20 includes a switch 21 having one terminal connected to an AC power source 8, and another terminal connected to one of the computer 3, the monitor 4 and the peripheral apparatus 5 to switch on or off the AC power of the AC power line connected to the receiving module 20 by receiving the control signal of standby power control module 10. The receiving module 20 can further include a second logic control unit 22 for monitoring a current passing through the switch 21, and transmitting a monitor signal back to the computer 3.

The standby power saving system 1 further includes a management unit 33. The management unit 33 is a user interface and provides an administrator setting menu for allowing a user to control the overall operations of the standby power saving system 1 by setting the administrator setting menu. The management unit 33 is installed in the computer 3 in a form of an application program to check whether the computer 3, the monitor 4 and the peripheral apparatus 5 are on operation condition. Then, according to the checking result or a command of the user, the control signal is transmitted to the first logic control unit 110 via the interface unit 120 to switch on or off the AC powers of the computer 3, the monitor 4 and/or the peripheral apparatus 5. The setting items of the administrator setting menu include presetting when the computer 3 will power off automatically and switch off its AC power; selecting the monitor 4 and/or the peripheral apparatus 5 that the user wants to switch on its AC power; and selecting the monitor 4 and/or the peripheral apparatus 5 that the user wants to switch off its AC power and setting a predetermined period of lying time to automatically switch off the AC power of the selected peripheral apparatus 5. For example, when the user sets that there is no input signal input from the mouse 6 or the keyboard 7 within 5 minutes, the AC power of the selected apparatus will be turned off via the management unit 33.

The standby power saving system 1 further includes at least one power control signal line 9 having one terminal connected to the standby power control module 10, and another terminal connected to the receiving module 20 for providing a transmission path of the control signal between the standby power control module 10 and the receiving module 20.

The power-off modes of the standby power saving system 1 include but are not limited to the following modes.

In power-off mode 1, when the user selects the peripheral apparatus 5, and wants to turn off its AC power via the management unit 33, and inputs a first AC power block command to the monitor 4 and/or the peripheral apparatus 5 via the management unit 33, the management unit 33 sends a first AC power block command to the standby power control module 10 to switch off the AC powers of the monitor and/or the peripheral apparatus 5.

In power-off mode 2, when the monitor 4 or the peripheral apparatus 5 is in a standby state for a predetermined period of time, the management unit 33 sends a second AC power block command to the standby power control module 10 to turn off the AC power of the monitor 4 or the peripheral apparatus 5.

In power-off mode 3, when the computer 3 doesn't receive any input signal from a mouse or a keyboard for a predetermined period of time, the management unit 33 sends a third AC power block command to the standby power control module 10 to turn off the AC power of the monitor 4 and/or the at least one peripheral apparatus 5. The AC power of the peripheral apparatus 5 will be turned off by the user on the management unit 33.

In power-off mode 4, when the user sets that the computer 3 will automatically turn off its AC power after a predetermined period of time, the management unit 33 sends a fourth AC power block command to the standby power control module 10 to turn off the AC power of the computer 3, the monitor 4 and the peripheral apparatus 5.

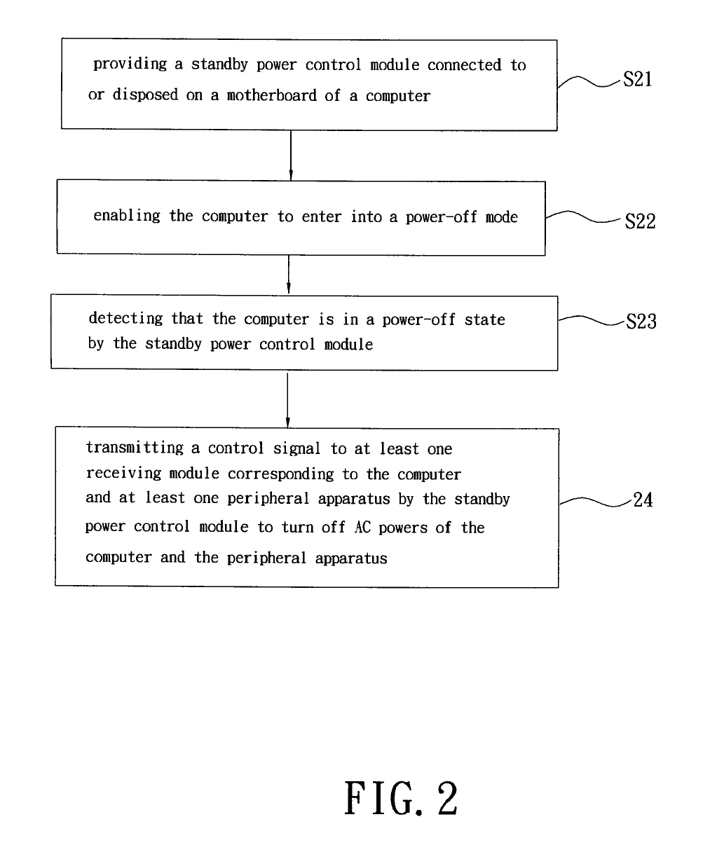

FIG. 2 is a flow chart illustrating a computer power-off method of a standby power saving system of the present invention. The computer power-off method of the standby power saving system 1 includes the following steps.

In step S21, a standby power control module 10 connected to or disposed on a motherboard 31 of a computer 3 is provided.

In step S22, the computer 3 enters into a power-off mode.

In step 23, the standby power control module 10 detects that the computer 3 is in a power-off state, wherein the standby power control module 10 detects a signal of an expanding slot 32 of the computer 3 via a first logic control unit 110 of the standby power control module 10 to confirm whether the computer 3 is in a power-off state and only standby power remains.

In step 24, the standby power control module 10 transmits a control signal to at least one receiving module 20 disposed on the AC power lines corresponding to the computer 3, the monitor and the at least one peripheral apparatus 5 to turn off the AC powers of the computer 3, the monitor 4 and the peripheral apparatus 5, wherein whether the AC power of the peripheral apparatus 5 is turned off is set by a default setting of the computer 3 or a setting by a user via a management unit 33.

The power-on modes of the standby power saving system 1 include but are not limited to the following modes.

In power-on mode 1, when the user inputs an AC power-on command to the monitor 4 and/or the at least one peripheral apparatus 5 via the management unit 33, the management unit 33 sends a first AC power-on command to the standby power control module 10 to switch on the AC powers of the monitor 4 and/or the at least one peripheral apparatus 5.

In power-on mode 2, when the peripheral apparatus 5 will be used, and the user selects the desired peripheral apparatus 5 via the management unit 33, the management unit 33 sends a second AC power-on command to the standby power control module 10 to switch on the AC power of the peripheral apparatus 5;

In power-on mode 3, when the computer 3 receives an input signal from a mouse or a keyboard, the management unit 33 sends a third power-on command to the standby power control module 10 to switch on the AC powers of the monitor 4 and the at least one peripheral apparatus 5; and

In power-on mode 4, when the AC powers of the computer 3, the monitor 4 and the peripheral apparatus 5 are turned off, and the standby power control module 10 senses that a power ON/OFF button of the computer 3 is pressed via the power ON/OFF button connecting port 150, the first logic control unit 110 transmits the control signal to the receiving modules 20 corresponding to the computer 3, the monitor 4 and the peripheral apparatus 5 to switch on the AC powers of the computer 3, the monitor 4 and the peripheral apparatus 5. Then, the power supply 34 recovers the standby power of the computer 3. Then, the standby power control module 10 transmits a power-on signal to the motherboard 31 via a motherboard connecting port 160. Then, the computer 3 enters into the power-on mode. Its procedures will be described in detail as follows.

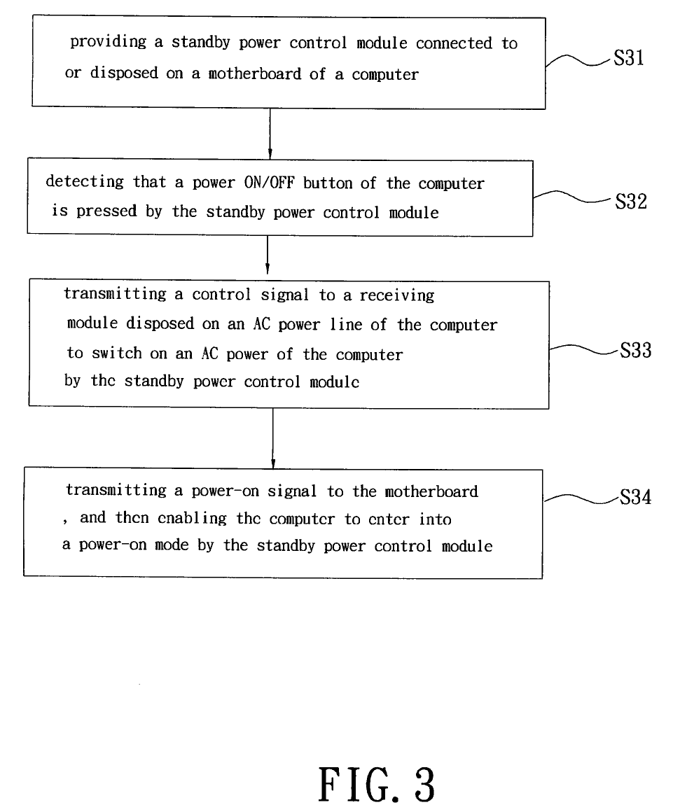

FIG. 3 is a flow chart illustrating a computer power-on method of a standby power saving system of the present invention. The computer power-on method includes the following steps.

In step 31, a standby power control module 10 connected to or disposed on a motherboard 31 of a computer 3 is provided.

In step 32, the standby power control module 10 detects that a power ON/OFF button of the computer 3 is pressed.

In step 33, the standby power control module 10 transmits a control signal to a receiving module 20 disposed on an AC power line of the computer 3 to switch on an AC power of the computer 3, wherein when the receiving module 20 corresponding to the computer 3 recovers the AC power of the computer 3, a power supply of the computer 3 switches on a standby power of the computer 3.

In step 34, the standby power control module 10 transmitting a power-on signal to the motherboard 31, and then the computer 3 enters into the power-on mode.

After the computer 3 is in a power-on state, the AC powers of the monitor 4 and the at least one peripheral apparatus 5 are recovered.

To sum up, by monitoring the conditions of the computer, the monitor and the peripheral apparatus connected to the computer, when the computer, the monitor and the peripheral apparatus are in a standby state for a predetermined period of time, the AC powers of the computer, the monitor and the peripheral apparatus are turned off, thereby reducing the consumed standby-power of the apparatuses.

When the computer enters into the power-off mode, and the standby power control module detects that the computer is in a power-off state, the standby power control module transmits a control signal to a plurality of receiving modules corresponding to the computer, the monitor and the peripheral apparatus to switch off the AC powers of the computer, the monitor and the peripheral apparatus.

When the AC powers of the computer, the monitor and the at least one peripheral apparatus are switched off, and the standby power control module detects that the power ON/OFF button of the computer is pressed, the AC power of the computer is recovered, and then the computer enters into the power-on mode. Then, the AC powers of the monitor and the peripheral apparatus are recovered.

Although the present invention has been described with reference to specific embodiment, this description is not meant to be construed in a limiting sense. Various modifications of the disclosed embodiment, as well as alternative embodiments, will be apparent to persons skilled in the art. It is, therefore, contemplated that the appended claims will cover all modifications that fall within the true scope of the present invention.

What is claimed is:

1. A standby power saving system comprising:
a standby power control module connected to or disposed on a motherboard of a computer for bidirectional signal transmission and transmitting a control signal; and
at least one receiving module disposed on at least one AC power line of the computer and/or at least one peripheral apparatus, and connected to the standby power control module for receiving the control signal to switch on or off AC power of the computer and/or the peripheral apparatus.

2. The standby power saving system according to claim 1, wherein the standby power control module is built on board and integrated onto the motherboard.

3. The standby power saving system according to claim 1, wherein the standby power control module is an interface card and inserted in an expanding slot of the motherboard for bidirectional signal transmission with the motherboard.

4. The standby power saving system according to claim 3, wherein the standby power control module further comprises an interface unit connected to the motherboard for allowing the control signal transmitted from the computer to the standby power control module.

5. The standby power saving system according to claim 1, wherein the standby power control module comprises:
a power module for providing a power to the standby power control module when an AC power of the computer is turn off; and
a first logic control unit for receiving the control signal from the computer to switch on or off the AC powers of the computer and/or the at least one peripheral apparatus.

6. The standby power saving system according to claim 5, wherein when the computer is in a power-on state, the power module is charged via the motherboard or an expanding slot of the motherboard.

7. The standby power saving system according to claim 5, wherein the standby power control module further comprises a driving and receiving unit for receiving and amplifying the control signal transmitted from the first logic control unit, and transmitting the control signal to the corresponding receiving module.

8. The standby power saving system according to claim 1, further comprising a management unit which is a user interface and provides an administrator setting menu for allowing a user to set the administrator set menu to control the overall operations of the standby power saving system.

9. The standby power saving system according to claim 8, wherein the management unit is installed in the computer in a form of an application program to check whether the computer and the peripheral apparatus are on operation condition, and then to switch on or off the AC powers of the computer and/or the peripheral apparatus according to the checking result or a command of the user.

10. The standby power saving system according to claim 8, wherein the setting items of the administrator setting menu comprises:
presetting when the computer will power off automatically and turn off its AC power;
selecting the peripheral apparatus that the user wants to recover its AC power; and
selecting the peripheral apparatus that the user wants to turn off its AC power, and automatically turning off its AC power of the selected peripheral apparatus by setting a predetermined period of standby time.

11. The standby power saving system according to claim 1, wherein the receiving module comprises:
a switch having one terminal connected to an AC power source, and another terminal connected to the corresponding computer or peripheral apparatus to switch on or off the AC power of the computer or the peripheral apparatus by receiving the control signal of the standby power control module.

12. The standby power saving system according to claim 11, wherein the receiving module further comprises a second logic control unit for monitoring a current passing through the switch and transmitting a monitor signal back to the computer.

13. The standby power saving system according to claim 1, further comprising at least one power control signal line having one terminal connected to the standby power control module, and another terminal connected to the receiving module for providing a transmission path of the control signal between the standby power control module and the receiving module.

14. The standby power saving system according to claim 8, wherein:
when the user inputs a first AC power block command to the peripheral apparatus via the management unit, the management unit sends a first AC power block command to the standby power control module to turn off the AC power of the peripheral apparatus;
when the peripheral apparatus is on a standby state for a predetermined period of time, the management unit sends a second AC power block command to the standby power control module to switch off the AC power of the peripheral apparatus;
when the computer doesn't receive any input signal from a mouse or a keyboard for a predetermined period of time, the management unit sends a third AC power block command to the standby power control module to switch off the AC power of the peripheral apparatus; and
when the user sets that the computer will automatically turn off its AC power after a predetermined period of time, the management unit sends a fourth AC power block command to the standby power control module to switch off the AC power of the computer and the peripheral apparatus.

15. The standby power saving system according to claim 8, wherein:
when the user inputs an AC power-on command relative to the peripheral apparatus via the management unit, the management unit sends a first AC power-on command to the standby power control module to switch on the AC power of the peripheral apparatus;
when the peripheral apparatus will be put to use, and the user selects the peripheral apparatus whose AC power will be recovered, the management unit sends a second AC power-on command to the standby power control module to switch on the AC power of the peripheral apparatus;
when the computer receives an input signal from a mouse or a keyboard, the management unit sends a third power-on command to the standby power control module to switch on the AC power of a monitor and the at least one peripheral apparatus; and
when the AC powers of the computer and the peripheral apparatus are turn off, and the standby power control module senses that a power ON/OFF button of the computer is pressed, the standby power control module transmits the control signal to the receiving module corresponding to the computer to switch on the AC power of the computer, thereby recovering a standby power of the computer, and then the computer enters into a power-on mode, and then the AC power of the peripheral apparatus is recovered.

16. The standby power saving system according to claim 5, wherein the standby power control module further comprises:
a power ON/OFF button connecting port having one terminal connected to a power ON/OFF button of the computer, and having another terminal connected to the first logic control unit for monitoring whether the power ON/OFF button is pressed; and
a motherboard connecting port having one terminal connected to the motherboard, and another terminal connected to the first logic control unit, wherein when the receiving module switches on the AC power of the computer, the standby power control module transmits a power-on signal to the motherboard, and then the computer enters into a power-on mode.

17. A computer power-off method of a standby power saving system comprising steps of:
providing a standby power control module connected to or disposed on a motherboard of a computer;
enabling the computer to enter into a power-off mode;
detecting that the computer is in a power-off state by the standby power control module; and
transmitting a control signal to at least one receiving module corresponding to the computer and at least one peripheral apparatus by the standby power control module to turn off AC powers of the computer and the peripheral apparatus.

18. The computer power-off method according to claim 17, wherein the standby power control module detects a signal of an expanding slot of the computer via a first logic control unit of the standby power control module to confirm whether the computer is in a power-off state and only standby power remains.

19. The computer power-off method according to claim 17, wherein the AC power of the peripheral apparatus is turn off via a default setting of the computer or a setting of a management unit by a user.

20. A computer power-on method of a standby power saving system when AC powers of a computer and at least one peripheral apparatus are turned off, comprising steps of:
providing a standby power control module connected to or disposed on a motherboard of a computer;
detecting that a power ON/OFF button of the computer is pressed by the standby power control module;
transmitting a control signal to a receiving module disposed on an AC power line of the computer to switch on an AC power of the computer by the standby power control module; and
transmitting a power-on signal to the motherboard, and then enabling the computer to enter into a power-on mode by the standby power control module.

21. The computer power-off method according to claim 20, wherein when the receiving module corresponding to the computer recovers the AC power of the computer, a power supply of the computer recovers a standby power of the computer.

22. The computer power-off method according to claim 20, wherein when the power ON/OFF button is pressed, the standby power control module senses that a power ON/OFF button is pressed by a power ON/OFF button connecting port of the standby power control module having one terminal connected to the power ON/OFF button.

23. The computer power-off method according to claim 20, wherein the standby power control module transmits a power-on signal to the motherboard via a motherboard connecting port of the standby power control module, which has one terminal connected to the motherboard.

24. The computer power-off method according to claim 20, wherein a power module of the standby power control module provides a power to the standby power control module when the AC power of the computer is turned off, and after the computer is in a power-on state, the AC power of the peripheral apparatus is turned on.
